(19) United States
(12) Patent Application Publication
(10) Pub. No.: US 2015/0227860 A1
(43) Pub. Date: Aug. 13, 2015

(54) DEFECT TURNAROUND TIME ANALYTICS ENGINE

(71) Applicant: International Business Machines Corporation, Armonk, NY (US)

(72) Inventors: Nicholas J. Baldo, Hamburg, NY (US); Anand K. Hariharan, Marietta, GA (US); Mark P. O'Connor, Greensboro, NC (US); Susan E. Smith, Talking Rock, GA (US)

(73) Assignee: International Business Machines Corporation, Armonk, NY (US)

(21) Appl. No.: 14/175,644

(22) Filed: Feb. 7, 2014

(51) Int. Cl. G06Q 10/06

(52) U.S. Cl. CPC G06Q 10/06

(57) ABSTRACT

In an approach for generating defect turnaround time metrics for assessing project status, a computer retrieves defect turnaround time criteria. The computer imports defect turnaround time data. Based, at least in part, on the defect turnaround time criteria, the computer analyzes the defect turnaround time data. The computer generates defect turnaround time metrics.

### FIELD OF THE INVENTION

The present invention relates generally to the field of software development, and more particularly to defect turnaround time analytics.

### BACKGROUND OF THE INVENTION

While software systems continue to grow in size and complexity, business demands continue to require shorter development cycles. This has led software developers to compromise on functionality, time to market, and quality of software products. Furthermore, the increased schedule pressures and limited availability of resources and skilled labor can lead to problems such as incomplete design of software products, inefficient testing, poor quality, high development and maintenance costs, and the like. This may lead to poor customer satisfaction and a loss of market share for companies developing software.

To improve product quality many organizations devote an increasing share of their resources to testing and identifying problem areas related to software and the process of software development. Accordingly, it is not unusual to include a quality assurance team in software development projects to identify defects in the software product during and after development of a software product. By identifying and resolving defects before marketing the product to customers, software developers can assure customers of the reliability of their products and reduce the occurrence of post-sale software fixes, such as patches and upgrades, which may frustrate their customers.

Testing and identifying problem areas related to software development may occur at different points or stages in a software development lifecycle. For example, a general software development lifecycle may include a high level requirements/design review, a detailed requirements/design review, a code inspection, a unit test, a system test, a system integration test, a performance test, and a user acceptance test. Moreover, as the software development lifecycle proceeds from high level requirements/design review to user acceptance test, the cost of detecting and remedying software defects generally increases.

The information-intensive nature of software engineering suggests that a strong potential exists for software project management to make great use of analysis, data, and systematic reasoning to make decisions. This data-centric style of decision making is known as analytics. The idea of analytics is to leverage potentially large amounts of data into real and actionable insights. The goal of analytics is to assist decision makers in extracting important information and insights from data sets that would otherwise be hidden.

### SUMMARY

Embodiments of the present invention disclose a method, computer program product, and system for generating defect turnaround time metrics for assessing project status. The method includes a computer retrieving defect turnaround time criteria. The computer imports defect turnaround time data. Based, at least in part, on the defect turnaround time criteria, the computer analyzes the defect turnaround time data. The computer generates defect turnaround time metrics.

### BRIEF DESCRIPTION OF THE SEVERAL VIEWS OF THE DRAWINGS

FIG. 1 is a functional block diagram illustrating a software development environment, in accordance with an embodiment of the present invention.

FIG. 2 is a flowchart depicting operational steps of a defect turnaround time software engine, on a client computing device within the software development environment of FIG. 1, in accordance with an embodiment of the present invention.

FIG. 3 illustrates an example of pre-defined criteria for measuring defect turnaround time, in accordance with an embodiment of the present invention.

FIG. 4 illustrates an example of defect turnaround time metrics for a software development project over a period of time, in accordance with an embodiment of the present invention.

FIG. 5 depicts a block diagram of components of the client computing device executing the defect turnaround time software engine, in accordance with an embodiment of the present invention.

### DETAILED DESCRIPTION

Often, when trying to effectively manage large, globally distributed complex software development and/or package implementation deployment projects, schedule attainment can be made or broken on the ability of the project to accurately measure, monitor, and react, as needed, to trend changes in how rapidly, on average, defects are moved from open to closed during a given test effort. As defect turnaround times begin to increase, for example, when large defect volumes are involved, it is imperative that a project manager quickly identify and address the root cause of a negative trend in order to address the appropriate issue before the trend endangers schedule attainment. It is necessary to gather data from the project to provide this level of insight on the defect turnaround time effectiveness so that problem trends can be identified as soon as they begin, and corrective action plans can be formulated in a time sensitive way. However, for the largest, most complex projects, where defect volumes are high, it is impractical for resources to manually perform this type of analysis on a recurring basis.

Embodiments of the present invention recognize that efficiency can be gained by implementing a tool that can analyze significant amounts of defect turnaround time data and provide useful trend information that, in turn, enables development of corrective actions that would not otherwise be feasible. Implementation of embodiments of the invention may take a variety of forms, and exemplary implementation details are discussed subsequently with reference to the Figures.

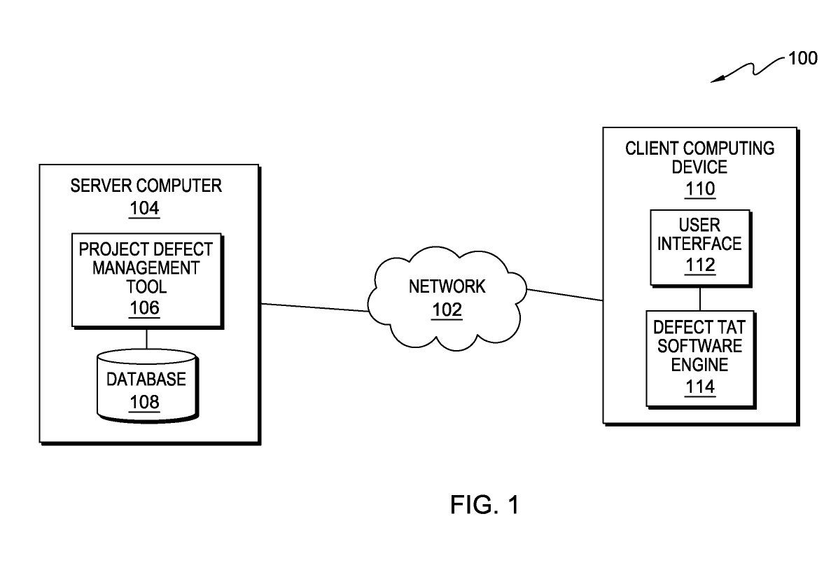

FIG. 1 is a functional block diagram illustrating a software development environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Software development environment 100 includes server computer 104 and client computing device 110, interconnected over network 102. Network 102 can be, for example, a local area network (LAN), a wide area network (WAN), such as the Internet, or a combination of the two, and can include wired, wireless, or fiber optic connections. In general, network 102 can be any combination of connections and protocols that will support communications between server computer 104 and client computing device 110.

Server computer 104 may be a management server, a web server, or any other electronic device or computing system capable of receiving and sending data. In other embodiments, server computer 104 may represent a server computing system utilizing multiple computers as a server system, such as in a cloud computing environment. In another embodiment, server computer 104 may be a laptop computer, tablet computer, netbook computer, personal computer (PC), a desktop computer, a personal digital assistant (PDA), a smart phone, or any programmable electronic device capable of communicating with client computing device 110 via network 102. In another embodiment, server computer 104 represents a computing system utilizing clustered computers and components to act as a single pool of seamless resources. Server computer 104 includes project defect management tool 106 and database 108.

Project defect management tool 106 is depicted residing on server computer 104; however, project defect management tool 106 may also reside on client computing device 110, provided it can communicate with database 108 over network 102. Project defect management tool 106 is one of a plurality of tools designed to manage a software development project and track defects that arise. For example, project defect management tool 106 may be a collaborative, web-based tool that offers comprehensive test planning, test construction, and test artifact management functions throughout the software development lifecycle.

Database 108 resides on server computer 104. In another embodiment, database 108 may reside on client computing device 110. A database is an organized collection of data. In one embodiment, database 108 contains data associated with defects recorded during a software development project by project defect management tool 106. For example, database 108 may store, without limitation, timestamp information with respect to when a defect entered and exited a particular phase of the defect resolution process. Database 108 may also contain additional data associated with the detected defects, such as severity, team responsible for fixing the defect, and the current state of the defect, for example, open or resolved.

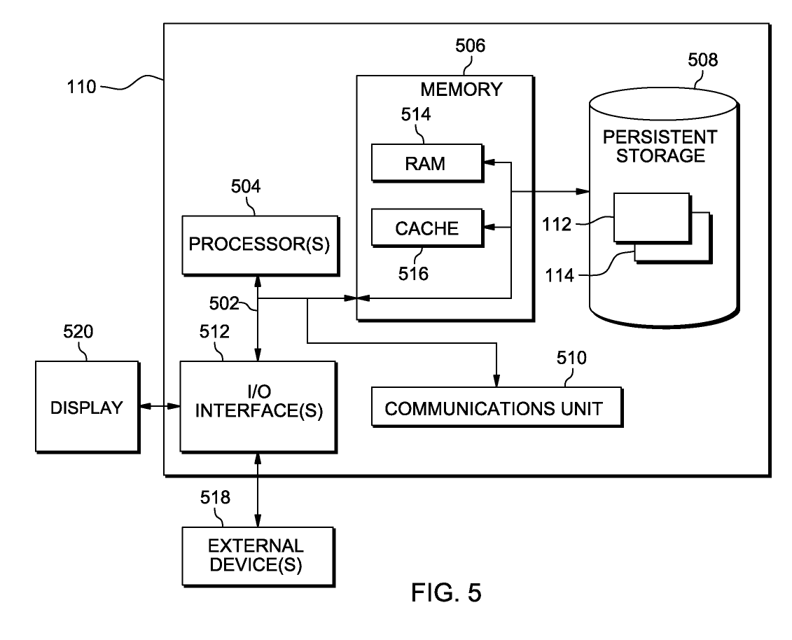

Client computing device 110 may be a desktop computer, a laptop computer, a tablet computer, a specialized computer server, a smart phone, or any programmable electronic device capable of communicating with server computer 104 via network 102 and with various components and devices within distributed data processing environment 100. In general, client computing device 110 represents any programmable electronic device or combination of programmable electronic devices capable of executing machine-readable program instructions and communicating with other computing devices via a network, such as network 102. Client computing device 110 includes user interface 112 and defect turnaround time software engine 114. Client computing device 110 may include internal and external hardware components, as depicted and described in further detail with respect to FIG. 5.

User interface 112 is a program that provides an interface between a user of client computing device 110 and project defect management tool 106 via network 102. A user interface, such as user interface 112, refers to the information (such as graphic, text, and sound) a program presents to a user and the control sequences the user employs to control the program. There are many types of user interfaces. In one embodiment, user interface 112 is a graphical user interface (GUI). A GUI is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements.

Defect turnaround time (TAT) software engine 114 is a computer program for providing detailed analytics around defect turnaround time that would otherwise be too time consuming to produce on a timely basis for a software development project. Defect TAT software engine 114 retrieves defect data from database 108 via network 102 and provides a user with analysis of that data which is beneficial to keeping a software development project on schedule. Defect TAT software engine 114 uses pre-defined criteria to generate the data analysis. In one embodiment, a user of defect TAT software engine 114 can divide the data into three defect life cycle phases for analysis. For example, life cycle phases may include triage, resolution, and retest. Triage can be defined as the period of time from when a defect is raised to when the defect is assigned to the correct fixer. Resolution can be defined as the period of time from the fixer receiving the defect assignment to verifying the defect is fixed. Retest can be defined as the period of time from when the tester receives notice that the defect is ready to be verified to the completion of the verification test. In another embodiment, the user of defect TAT software engine 114 may determine that dividing the data into more than three life cycle phases is desirable to add additional granularity to the data analysis.

In another embodiment, a user of defect TAT software engine 114 may allocate target turnaround times by the severity of the defect. A defect may be defined as a severity level of 1 (sev 1) if the defect causes a user of the software to be unable to perform any tasks. A defect may be defined as a severity level of 2 (sev 2) if the user of the software can work around the defect, but not in an efficient manner. A user of defect TAT software engine 114 can define a target turnaround time for each type of defect, for example, for sev 1 defects, the target may be defined as 24 hours, and for sev 2 defects the target may be defined as 48 hours. In yet another embodiment, a user of defect TAT software engine 114 may define the amount of time a particular defect is targeted to spend in each life cycle phase. For example, when 24 hours are slotted for a sev 1 defect, the user may elect to allocate 50% of the time to the resolution phase, with 25% to triage, and 25% to retest, for a total of 100% allocation of expected effort by process area or responsible team.

In yet another embodiment, a user of defect TAT software engine 114 can also set specific “tolerance thresholds” based on individual project needs for what results will or will not be acceptable to meet the overall defect turnaround time needs relative to the software test schedule. For example, a user may define color-coded criteria, such as green, yellow, and red, to indicate the status of the defect turnaround time with respect to the targets for a particular category of defects. In another embodiment, a user of defect TAT software engine 114 can determine what, if any, outlier logic should be applied to results, and further determine what specific failing applications or other project teams/units need to be measured or evaluated in terms of their defect turnaround time, as well as how many levels will be assessed.

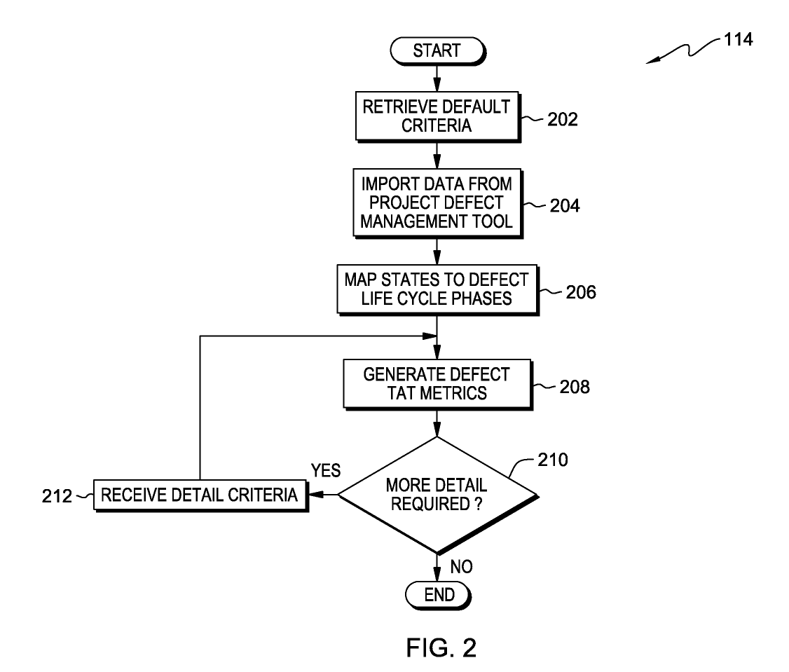

The pre-defined criteria and thresholds enable an automated method for a user to make a rapid assessment of the overall project as well as lower-level components with respect to performance against expected thresholds and targets. In this way, the user can monitor results in a real time fashion, and, for example, if a particular defect life cycle phase is not meeting expectations, corrective actions can be directed with specificity to the teams that are responsible for that part of the software development process. Defect TAT software engine 114 is depicted and described in further detail with respect to FIG. 2.

FIG. 2 is a flowchart depicting operational steps of defect turnaround time software engine 114, on client computing device 110 within software development environment 100 of FIG. 1, in accordance with an embodiment of the present invention.

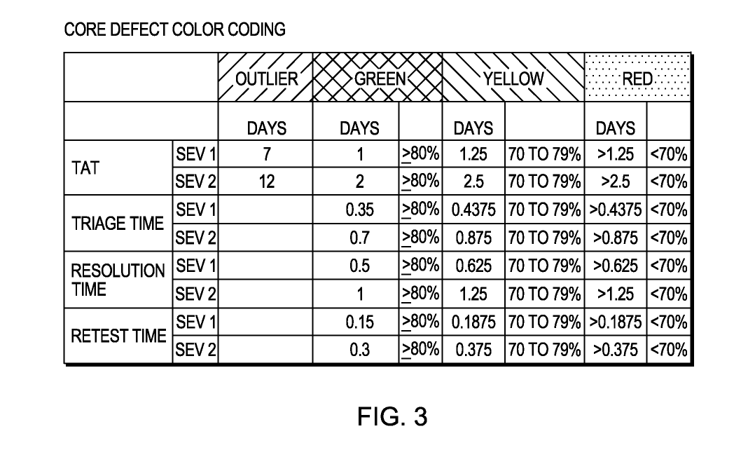

Defect turnaround time (TAT) software engine 114 retrieves default criteria (step 202). As a software development project begins, a project manager may pre-define the default criteria that the project will be measured against. In one embodiment, the project manager may determine the target turnaround times for defects of each severity. For example, the target TAT for a sev 1 defect may be set at 24 hours, while the target TAT for a sev 2 defect may be set at 48 hours. In another embodiment, the project manager may allocate desired proportions of the defect TAT to the various life cycle phases. For example, the project manager may allocate 50% of the TAT of a sev 1 defect to resolution, 25% of the TAT to triage, and 25% of the TAT to retest. In this example, if the target for a sev 1 defect is completion of all three life cycle phases in 24 hours, then the expectation is that 12 hours is allocated to resolution, with 6 hours allocated to each triage and retest. In another embodiment, the project manager may create color-coded tolerance levels with associated time ranges. For example, “green” may be defined as a TAT within a specified range. “Yellow” may be defined as a TAT somewhat outside of the specified range, for example, 20% more time than the specified range. “Red” may be defined as a TAT significantly outside of the specified range, for example, 50% more time than the specified range. If the acceptable range of a sev 1 defect is specified as 0 to 24 hours, a defect with a TAT of 18 hours is considered green, where a defect with a TAT of 30 hours may be considered yellow, and a defect with a TAT of 48 hours may be considered red. An example of pre-defined criteria for measuring defect turnaround time is depicted and described in further detail with respect to FIG. 3.

In another embodiment, the project manager may determine what, if any, outlier logic should be applied to the results of the data analysis performed by defect TAT software engine 114. An outlier is a data point that is well outside the expected range of values. A threshold can be set such that if the TAT is outside the threshold, the defect is considered an outlier and is removed from the analysis. For example, if a defect can not be resolved until a third-party product is updated, and that update is expected to take a week, that defect is removed from the data analysis if the project manager sets the outlier threshold to three days. In another embodiment, outlier data points may be included in the analysis and highlighted in a way that the project manager can review each data point to determine whether it is considered an outlier or another issue of concern.

The default criteria may be stored in database 108 prior to the start of execution of defect TAT software engine 114. In one embodiment, a user, such as a project manager, inputs the default criteria via user interface 112.

Defect TAT software engine 114 imports data from project defect management tool 106 (step 204). Project defect management tool 106 may continually collect defect data for a project. Defect data includes timestamps of when a defect is reported, as well as when the defect moves through the defect life cycle phases. Other data collected for each defect may include the severity of the defect, the team or sub-team responsible for fixing the defect, the current state of the defect (e.g. open or resolved), etc. Defect TAT software engine 114 imports this data in order to perform analysis. In one embodiment, the data is exported from project defect management tool 106 via spreadsheet software, and defect TAT software engine 114 imports the data from the spreadsheet.

Subsequent to importing data from project defect management tool 106, defect TAT software engine 114 maps the states of each defect to life cycle phases (step 206). Defect TAT software engine 114 analyzes the timestamps of each movement of the defect and maps the state of the defect from project defect management tool 106 to life cycle phases. As discussed above, the key life cycle phases may include triage, resolution, and retest. Triage can be defined as the period of time from when a defect is raised to when the defect is assigned to the correct fixer. Resolution can be defined as the period of time from the fixer receiving the defect assignment to verifying the defect is fixed. Retest can be defined as the period of time from when the tester receives notice that the defect is ready to be verified to the completion of the verification test. The life cycle phases are defined in order to aid in the review of the data analysis produced by defect TAT software engine 114. In addition to sorting the data into life cycle phases, defect TAT software engine 114 may also sort defects by core defect versus design defect. A core defect is considered a standard software defect that it is detected during execution testing and determined to cause a failure in the software functionality. A design defect is, for example, due to a missed requirement. The software may function with a design defect, but it may not meet the customer's requirements. A modification to the software is needed to fix a design defect.

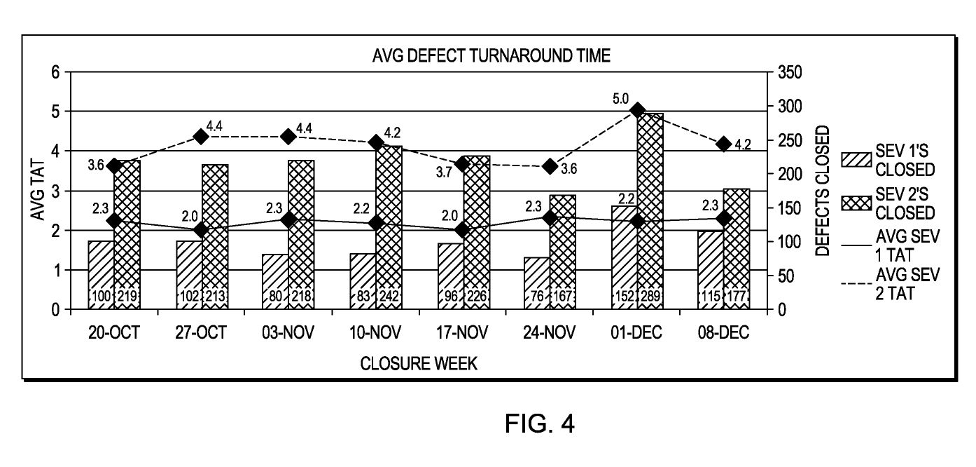

Defect TAT software engine 114 generates defect TAT metrics (step 208). Defect TAT software engine 114 assimilates the timestamp and other defect data that was imported from project defect management tool 106 with the retrieved default criteria, and generates defect TAT metrics. For example, defect TAT software engine 114 may generate an average overall defect TAT in hours against the designated target by time period measured (e.g. day, week, month) and severity. In another example, defect TAT software engine 114 may generate a total number of defects closed in the measured time period by severity. In a further example, defect TAT software engine 114 may generate specific breakouts of the previous examples by life cycle phase in order to help the project manager identify specific corrective actions by process area. An example of defect TAT metrics is depicted and described in further detail with respect to FIG. 4.

Subsequent to generating defect TAT metrics, defect TAT software engine 114 determines whether more detail is required (decision block 210). If no more detail is required, defect TAT software engine 114 ends execution (no branch, decision block 210). If more detail is required (yes branch, decision block 210), defect TAT software engine 114 receives detail criteria (step 212). Via user interface 112, defect TAT software engine 114 receives input from a user, such as a project manager, regarding additional detail needed for the defect TAT metrics. Often, to determine the root cause of a defect failing to meet a target turnaround time, the project manager may need drill down further into the details of the failure. For example, the project manager may want to view which specific teams are responsible for the delayed resolution. The project manager may find that a particular team lacking sufficient resources is the root cause for that team's slow response. In one embodiment, defect TAT software engine 114 displays a list of additional reports that can be generated via user interface 112, and the project manager chooses a report from the list. For example, the project manager may require a more detailed version of the overall defect turnaround time, where defects are divided into categories such as “core defect” and “design defect”. In another example, the project manager may require a report that lists specific failing applications or specific teams for a more granular evaluation. In addition, the project manager may want the list of core defect turnaround times displayed by team. In another embodiment, the project manager may be able to edit the default criteria via user interface 112 and have defect TAT software engine 114 generate new metrics based on new criteria. Upon satisfying the user's requirement of additional detail, defect TAT software engine 114 ends execution.

FIG. 3 illustrates an example of a table of pre-defined criteria for measuring defect turnaround time, in accordance with an embodiment of the present invention. A user of defect TAT software engine 114, such as a project manager, defines the criteria for the defect data TAT analysis prior to executing step 202 of defect TAT software engine 114, as referred to in the discussion of FIG. 2. In this example, the defect TAT criteria are defined for core defects.

In the first column of the table, the measurement categories are listed. In this example, the measurement categories are overall turnaround time (TAT), triage time, resolution time, and retest time. Each category is divided into defect severity levels 1 and 2 (sev 1, sev 2), as shown in the second column. Defect severity levels are often defined by the project manager. The third column is labeled “outlier”, and lists the time, in days, in which a defect would be considered an outlier from the rest of the data. In this example, a sev 1 defect is considered an outlier if the overall turnaround time is 7 or more days, and a sev 2 defect is considered an outlier if the overall turnaround time is 12 or more days. As discussed earlier, an outlier defect TAT may be due to unusual circumstances that are not under the control of the team to which the defect has been assigned, for example, a third-party product update.

The next three columns are labeled green, yellow, and red, respectively, and represent the measurement criteria that are used for the analysis. In general, green represents acceptable results, while yellow represents results that are somewhat unsatisfactory, and red represents unacceptable results. The user of defect TAT software engine 114 may define these categories such that a quick, visual review of the defect TAT metrics indicates which areas need improvement.

Each of the color-coded columns is sub-divided into two columns. The left column is the target turnaround time in days. For example, for a sev 1 defect TAT to be considered “green”, the defect must be resolved through the three life cycle phases in one day. The right column is the percentage of the average turnaround time of all the defects in a particular category that meet the target. For example, if 80% or more of all the defects in a particular category are resolved within the target TAT, that category is considered “green”. Similar definitions are provided for the yellow and red columns.

As noted earlier, in the current example, the target TAT for a sev 1 defect is one day. The one day target is divided into the three life cycle phases. For example, 0.35 days are allotted to triage time for a sev 1 defect, while 0.5 days are allotted to resolution time and 0.15 days are allotted to retest time. The sum of the three allotments equals the one day target. In this example, the project manager has determined that the life cycle phase that requires the most time is resolution, while retest should take the least amount of time.

FIG. 4 illustrates an example of defect turnaround time metrics for a software development project over a period of time, in accordance with an embodiment of the present invention. This example indicates the average defect turnaround time for a software development project over a period of time, by week the defect was closed, from October 20^{th} through December 8^{th}, as represented by the horizontal axis.

The left vertical axis shows the average turnaround time in days and is used with the line portion of the graph. The lower line indicates the average turnaround time, by week, for sev 1 defects closed that week. The upper line indicates the average turnaround time, by week, for sev 2 defects closed that week. The result for each week is marked with a diamond that is labeled with the average turnaround time, in days. There may be an option to color code the diamonds such that they reflect green, yellow, and red target criteria. The line portion of the graph enables a visual indication of the trend of the defect turnaround time over time.

The right vertical axis shows the quantity of defects closed and is used with the bar portion of the graph. For each week, there is a bar to indicate the volume of defects closed, by severity. In this example, the left bar indicates the volume of sev 1 defects closed, and the right bar indicates the volume of sev 2 defects closed. The bar portion of the graph enables a visual indication of comparison of volume of sev 1 defects to that of sev 2 defects, as well as the trend of the volume of defects over time. The graph shown in FIG. 4 is only one example of metrics that can be generated by defect TAT software engine 114 and does not imply any limitation to the metrics that can be generated by defect TAT software engine 114. As discussed earlier, there are many metrics that can be generated by defect TAT software engine 114, and the user of defect TAT software engine 114 can define the desired metrics at the beginning of a software development project, as well as refine the desired metrics as the project progresses.

FIG. 5 depicts a block diagram of components of client computing device 110 in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Client computing device 110 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications, and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media.

User interface 112 and defect TAT software engine 114 are stored in persistent storage 508 for execution and/or access by one or more of the respective computer processor(s) 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, a read-only memory (ROM), an erasable programmable read-only memory (EPROM), a flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices, including resources of server computer 104. In these examples, communications unit 510 includes one or more network interface cards. Communications unit 510 may provide communications through the use of either or both physical and wireless communications links. User interface 112 and defect TAT software engine 114 may be downloaded to persistent storage 508 through communications unit 510.

I/O interface(s) 512 allows for input and output of data with other devices that may be connected to client computing device 110. For example, I/O interface(s) 512 may provide a connection to external device(s) 518 such as a keyboard, a keypad, a touch screen, and/or some other suitable input device. External device(s) 518 can also include portable computer-readable storage media such as, for example, thumb drives, portable optical or magnetic disks, and memory cards. Software and data used to practice embodiments of the present invention, e.g., user interface 112 and defect TAT software engine 114 can be stored on such portable computer-readable storage media and can be loaded onto persistent storage 508 via I/O interface(s) 512. I/O interface(s) 512 also connect to a display 520.

Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for generating defect turnaround time metrics for assessing project status, the method comprising:
a computer retrieving defect turnaround time criteria;
the computer importing defect turnaround time data;
the computer analyzing based, at least in part, on the defect turnaround time criteria, the defect turnaround time data; and
the computer generating defect turnaround time metrics.

2. The method of claim 1, wherein defect turnaround time criteria includes pre-defined criteria for assessing defect turnaround time, wherein pre-defined criteria for assessing defect turnaround time include target turnaround time per life cycle phase, per severity level, or per assigned team.

3. The method of claim 1, wherein defect turnaround time data includes at least one of timestamp data and a movement of a defect through a life cycle.

4. The method of claim 1, wherein analyzing the defect turnaround time data further comprises the computer mapping the defect turnaround time data to one or more life cycle phases, wherein the one or more life cycle phases include one or more of triage, resolution, and retest.

5. The method of claim 1, further comprising:
subsequent to generating defect turnaround time metrics, the computer determining further defect turnaround time metrics are required to further define the generated defect turnaround time metrics;
the computer receiving additional defect turnaround time criteria;
the computer analyzing based, at least in part, on the additional defect turnaround time criteria, wherein the additional defect turnaround time criteria specifies additional detail, the defect turnaround time data; and
the computer generating the further defect turnaround time metrics.

6. The method of claim 1, wherein defect turnaround time metrics include a comparison of an amount of time a defect resides in one or more life cycle phases to a target turnaround time.

7. The method of claim 1, further comprising:
the computer determining whether the defect turnaround time data includes outlier data;
responsive to determining the defect turnaround time data includes outlier data, the computer determining if the defect turnaround time criteria includes a threshold criteria for outlier data; and
responsive to determining the defect turnaround time criteria includes a threshold criteria for outlier data, the computer applying the threshold criteria for the outlier data.

8. A computer program product for generating defect turnaround time metrics for assessing project status, the computer program product comprising:
one or more computer-readable storage media and program instructions stored on the one or more computer-readable storage media, the program instructions comprising:
program instructions to retrieve defect turnaround time criteria;
program instructions to import defect turnaround time data;
program instructions to analyze, based, at least in part, on the defect turnaround time criteria, the defect turnaround time data; and
program instructions to generate defect turnaround time metrics.

9. The computer program product of claim 8, wherein defect turnaround time criteria includes pre-defined criteria for assessing defect turnaround time, wherein pre-defined criteria for assessing defect turnaround time include target turnaround time per life cycle phase, per severity level, or per assigned team.

10. The computer program product of claim 8, wherein defect turnaround time data includes at least one of timestamp data and a movement of a defect through a life cycle.

11. The computer program product of claim 8, wherein analyzing the defect turnaround time data further comprises program instructions to map the defect turnaround time data to one or more life cycle phases, wherein the one or more life cycle phases include one or more of triage, resolution, and retest.

12. The computer program product of claim 8, further comprising:
subsequent to generating defect turnaround time metrics, program instructions to determine further defect turnaround time metrics are required to further the generated defect turnaround time metrics;
program instructions to receive additional defect turnaround time criteria;
program instructions to analyze, based, at least in part, on the additional defect turnaround time criteria, wherein the additional defect turnaround time criteria specifies additional detail, the defect turnaround time data; and
program instructions to generate the further defect turnaround time metrics.

13. The computer program product of claim 8, wherein defect turnaround time metrics include a comparison of an amount of time a defect resides in one or more life cycle phases to a target turnaround time.

14. The computer program product of claim 8, further comprising:
program instructions to determine whether the defect turnaround time data includes outlier data;
responsive to determining the defect turnaround time data includes outlier data, program instructions to determine if the defect turnaround time criteria includes a threshold criteria for outlier data; and
responsive to determining the defect turnaround time criteria includes a threshold criteria for outlier data, program instructions to apply the threshold criteria for the outlier data.

15. A computer system for generating defect turnaround time metrics for assessing project status, the computer system comprising:
one or more computer processors;
one or more computer-readable storage media;
program instructions stored on the computer-readable storage media for execution by at least one of the one or more processors, the program instructions comprising:
program instructions to retrieve defect turnaround time criteria;
program instructions to import defect turnaround time data;
program instructions to analyze, based, at least in part, on the defect turnaround time criteria, the defect turnaround time data; and
program instructions to generate defect turnaround time metrics.

16. The computer system of claim 15, wherein defect turnaround time criteria includes pre-defined criteria for assessing defect turnaround time, wherein pre-defined criteria for assessing defect turnaround time include target turnaround time per life cycle phase, per severity level, or per assigned team.

17. The computer system of claim 15, wherein analyzing the defect turnaround time data further comprises program instructions to map the defect turnaround time data to one or more life cycle phases, wherein the one or more life cycle phases include one or more of triage, resolution, and retest.

18. The computer system of claim 15, further comprising:
subsequent to generating defect turnaround time metrics, program instructions to determine further defect turnaround time metrics are required to further define the generated defect turnaround time metrics;
program instructions to receive additional defect turnaround time criteria;
program instructions to analyze, based, at least in part, on the additional defect turnaround time criteria, wherein the additional defect turnaround time criteria specifies additional detail, the defect turnaround time data; and
program instructions to generate the further defect turnaround time metrics.

19. The computer system of claim 15, wherein defect turnaround time metrics include a comparison of an amount of time a defect resides in one or more life cycle phases to a target turnaround time.

20. The computer system of claim 15, further comprising:
program instructions to determine whether the defect turnaround time data includes outlier data;
responsive to determining the defect turnaround time data includes outlier data, program instructions to determine if the defect turnaround time criteria includes a threshold criteria for outlier data; and
responsive to determining the defect turnaround time criteria includes a threshold criteria for outlier data, program instructions to apply the threshold criteria for the outlier data.
